(19) United States
(12) Patent Application Publication
(10) Pub. No.: US 2013/0067438 A1
(43) Pub. Date: Mar. 14, 2013

(54) MANAGING THREAD EXECUTION IN A NON-STOP DEBUGGING ENVIRONMENT

(71) Applicant: International Business Machines Corpora, Armonk, NY (US)

(72) Inventor: CARY L. BATES, ROCHESTER, MN (US)

(73) Assignee: INTERNATIONAL BUSINESS MACHINES CORPORATION, ARMONK, NY (US)

(21) Appl. No.: 13/674,397

(22) Filed: Nov. 12, 2012

Related U.S. Application Data
(63) Continuation of application No. 13/085,725, filed on Apr. 13, 2011.

(51) Int. Cl. G06F 9/46; G06F 9/44

(52) U.S. Cl. 717/124

(57) ABSTRACT

Managing thread execution in a non-stop debugging environment that includes a debugger configured to debug a multi-threaded debuggee, where encountering an event by one of the threads stops execution of only the one thread without concurrently stopping execution of other threads, and managing thread execution includes: setting, by the debugger responsive to one or more user requests, one or more threads of the debuggee for auto-resumption; encountering, by a thread of the debuggee, an event stopping execution of the thread; determining whether the thread is set for auto-resumption; if the thread is set for auto-resumption, resuming, by the debugger, execution of the thread automatically without user interaction; and if the thread is not set for auto-resumption, processing, by the debugger, the event stopping execution of the thread.

### CROSS-REFERENCE TO RELATED APPLICATION

This application is a continuation application of and claims priority from U.S. patent application Ser. No. 13/085,725, filed on Apr. 13, 2011.

### BACKGROUND OF THE INVENTION

1. Field of the Invention

The field of the invention is data processing, or, more specifically, methods, apparatus, and products for managing thread execution in a non-stop debugging environment.

2. Description of Related Art

Software source code is increasingly complex and execution of such software may be multi-threaded. Software development is evolving to provide enhanced methods of debugging multi-threaded software applications. In traditional debugging, an event encountered by any one thread stops execution of all threads of the multi-threaded solution. This form of debugging may be referred to as ‘all-stop’ debugging. in contrast to all-stop debugging, the enhanced multi-threaded debugging enables an event encountered by one thread to stop only that one thread's execution while all other threads remain executing. This form of debugging is referred to as non-stop debugging. Non-stop debugging is a bit of a misnomer, however, in that some threads actually do stop execution. The primary difference between non-stop and all stop debugging, is that in non-stop debugging execution of all threads of a multi-threaded program need not be stopped upon a single thread encountering an event, while in all-stop debugging execution of all threads is stopped upon a single thread of the multi-threaded application encountering an event. While non-stop debugging provides many benefits, non-stop debugging also presents many challenges.

### SUMMARY OF THE INVENTION

Methods, apparatus, and products for managing thread execution in a non-stop debugging environment are disclosed. The non-stop debugging environment includes a debugger configured to debug a debuggee, where the debuggee includes a number of threads of execution. In the non-stop debugging environment, encountering an event by one of the threads stops execution of only the one thread without concurrently stopping execution of other threads. In such a non-stop debugging environment, management thread execution in accordance with embodiments of the present invention includes, setting, by the debugger responsive to one or more user requests, one or more threads of the debuggee for auto-resumption; encountering, by a thread of the debuggee, an event stopping execution of the thread; determining whether the thread is set for auto-resumption; if the thread is set for auto-resumption, resuming, by the debugger, execution of the thread automatically without user interaction; and if the thread is not set for auto-resumption, processing, by the debugger, the event stopping execution of the thread.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for managing thread execution in a non-stop debugging environment according to embodiments of the present invention.

FIG. 2 sets forth an example non-stop debugging GUI presented to a user in accordance with embodiments of the present invention.

FIG. 3 sets forth another example non-stop debugging GUI presented to a user in accordance with embodiments of the present invention.

FIG. 4 sets forth a flow chart illustrating an exemplary method for managing thread execution in a non-stop debugging environment according to embodiments of the present invention.

FIG. 5 sets forth a flow chart illustrating a further exemplary method for managing thread execution in a non-stop debugging environment according to embodiments of the present invention.

FIG. 6 sets forth a flow chart illustrating a further exemplary method for managing thread execution in a non-stop debugging environment according to embodiments of the present invention.

FIG. 7 sets forth a flow chart illustrating a further exemplary method for managing thread execution in a non-stop debugging environment according to embodiments of the present invention.

FIG. 8 sets forth a flow chart illustrating a further exemplary method for managing thread execution in a non-stop debugging environment according to embodiments of the present invention.

### DETAILED DESCRIPTION OF EXEMPLARY EMBODIMENTS

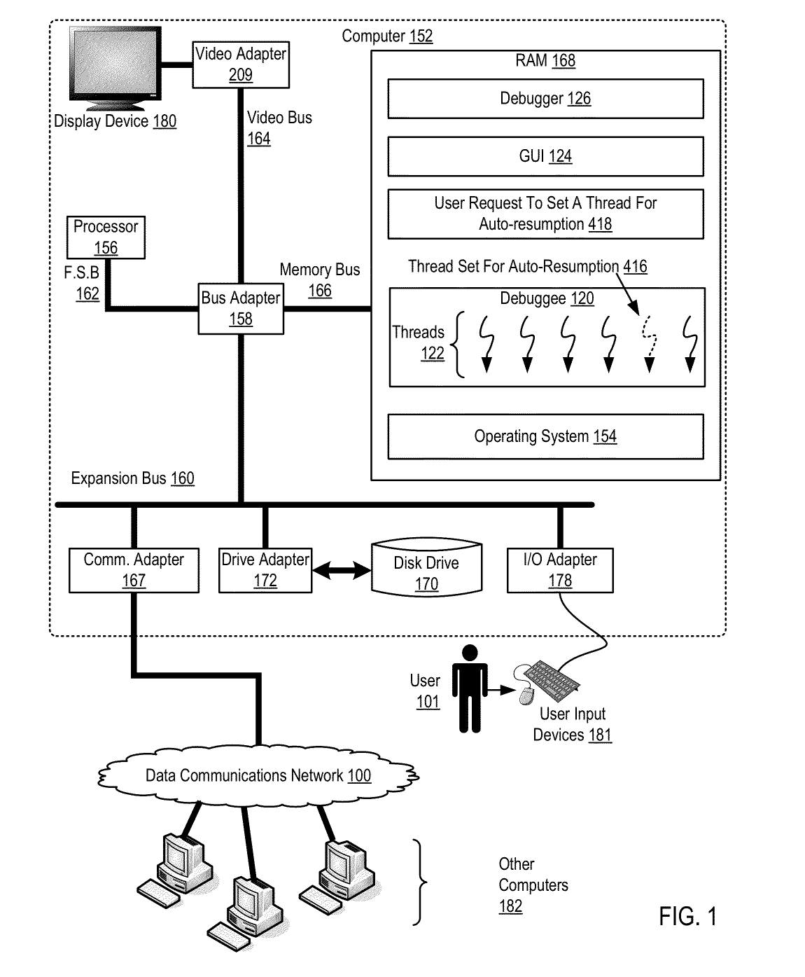

Exemplary methods, apparatus, and products for managing thread execution in a non-stop debugging environment in accordance with the present invention are described with reference to the accompanying drawings, beginning with FIG. 1. FIG. 1 sets forth a block diagram of a system for managing thread execution in a non-stop debugging environment according to embodiments of the present invention. The system of FIG. 1 includes automated computing machinery comprising an exemplary computer (152) useful in managing thread execution in a non-stop debugging environment according to embodiments of the present invention. The computer (152) of FIG. 1 includes at least one computer processor (156) or ‘CPU’ as well as random access memory (168) (RAM') which is connected through a high speed memory bus (166) and bus adapter (158) to processor (156) and to other components of the computer (152).

Stored in RAM (168) are a debugger (126) and a debuggee (120). A debugger (126) is an application that controls operation of another application—the debuggee (120)—for the purpose of testing execution of the debuggee. The source code of the debuggee may run on an instruction set simulator (ISS), a technique that allows great power in its ability to halt when specific conditions are encountered but which will typically be somewhat slower than executing the code directly on a processor for which the code is written. When execution of a program crashes or reaches a preset condition, a debugger typically displays the position in the source code at which the execution of the program crashed. A ‘crash’ occurs when the program cannot normally continue because of a programming bug. In addition to displaying a position in source code when execution of the source code crashes, debuggers also often offer other functions such as running a program step by step (single-stepping or program animation), stopping, breaking, or pausing the program to examine the current state, at some event or specified instruction by means of a breakpoint, and tracking the values of some variables.

In the example system of FIG. 1, the debugger (126) presents a graphical user interface (124) as a front-end of the debugger (126). Front-ends are extensions to debugger engines that provide Integrated Development Environment (‘IDE’) integration, program animation, and visualization features, rather than console-based command line interfaces. The ‘front-end’ directly faces a client—or user—in contrast to the debugger (126) in the example of FIG. 1, which interfaces indirectly with the clients through the GUI (124).

In the example system of FIG. 1, the debuggee (120) is a software application that executes as a process containing a number of threads (122) of execution. A ‘thread’ of execution as the term is used here refers to the smallest unit of processing that can be scheduled by an operating system. A thread generally results from a fork of a computer program into two or more concurrently running threads. The implementation of threads and processes differs from one operating system to another, but in most cases, a thread is contained inside a process. Multiple threads can exist within the same process and share resources such as memory, while different processes do not share these resources. In particular, the threads of a process share the process's computer program instructions and its context—the values that the process's variables reference at any given moment.

The system of FIG. 1 includes a non-stop debugging environment that includes the debugger (126) and the debuggee (120). The debugger supports non-stop debugging by insuring that when one thread of a multi-threaded debuggee encounters an event, execution of only that one of threads stops, without concurrently stopping execution of other threads. Consider, for example, a multi-threaded debuggee that includes three threads. In a non-stop debug environment, when one of the threads encounters an event, execution of that thread is stopped, but execution of the remaining two threads continues unabated. Either of other two threads may then separately encounter an event, stopping execution of that thread, but no other thread. By contrast, a traditional all-stop debugging environment insures that all threads are stopped concurrently with any one thread encountering an event. Continuing with the above example of a triple threaded debuggee, when any one of the three threads encounters an event in a traditional all-stop debug environment, all three threads halt execution.

An event is a predefined occurrence during execution of a debuggee. Examples of events which may be encountered during execution of the debuggee include breakpoints, watchpoints, catchpoints, and the like. A breakpoint is a specification of a source code location at which a debuggee will pause or stop execution. A watchpoint is a breakpoint configured to pause or stop execution of the debuggee when a value of a particular expression changes. A catchpoint is another type of breakpoint configured to pause or stop execution of the debuggee when a specified event occurs such as the throwing of an exception or a load of a library, and so on.

In addition to supporting non-stop debugging, the debugger (126) in the example of FIG. 1 is also configured for managing thread execution in the non-stop debugging environment in accordance with embodiments of the present invention. Managing thread execution in accordance with embodiments of the present invention includes setting, by the debugger (126) responsive to one or more user requests (418), one or more threads (416) of the debuggee (120) for auto-resumption. Auto-resumption as the term is used here describes a thread for which the debugger will resume automatically—that is, without user interaction—when execution of that thread is stopped. That is, every time a thread set for auto-resumption encounters a breakpoint, watchpoint, catchpoint, exception or the like, the debugger immediately (or nearly so) resumes the thread. From the user's perspective, a thread set for auto-resumption is effectively an ‘unstoppable’ thread. That is, from the user's perspective a thread set for auto-resumption never stops. In this way, a software developer controlling the example non-stop debugger (126) of FIG. 1 may limit the impact of debugging for selected threads. Threads implementing services of a product sales server, for example, may be set to auto-resume such that performance degradation introduced by debugging is limited and possibly unnoticed from the perspective of third-party buyers (not the user of the debugger) utilizing the services of the product sales server.

Once one or more threads (122) are set for auto-resumption in the system of FIG. 1, any thread may then encounter an event stopping execution of the thread. The example debugger (126) of FIG. 1 may then determine whether the thread is set for auto-resumption. If the thread is set for auto-resumption, the debugger resumes execution of the thread automatically without user interaction—that is, in the background. If the thread is not set for auto-resumption, the debugger processes the event stopping execution of the thread. ‘Processing’ an event as the term is used here refers to typical event processing—changing the debug perspective to the thread encountering the event, displaying on the GUI (124) variable values, expressions, event information, call stacks, and the like, associated with the thread encountering the event or the event itself. Said another way, if a thread encountering an event is not set for auto-resumption, the debugger operates as normal—processing the event as any other event is processed.

Also stored in RAM (168) is an operating system (154). Operating systems useful in computers configured for managing thread execution in a non-stop debugging environment according to embodiments of the present invention include UNIX™, Linux™, Microsoft XP™, AIX™, IBM's I™, and others as will occur to those of skill in the art. The operating system (154), debugger (126), debuggee (126), and GUI (124) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers that operate for managing thread execution in a non-stop debugging environment according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user (101) input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for managing thread execution in a non-stop debugging environment according to embodiments of the present invention include modems for wired dial-up communications, Ethernet (IEEE 802.3) adapters for wired data communications network communications, and 802.11 adapters for wireless data communications network communications.

The arrangement of computers, networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

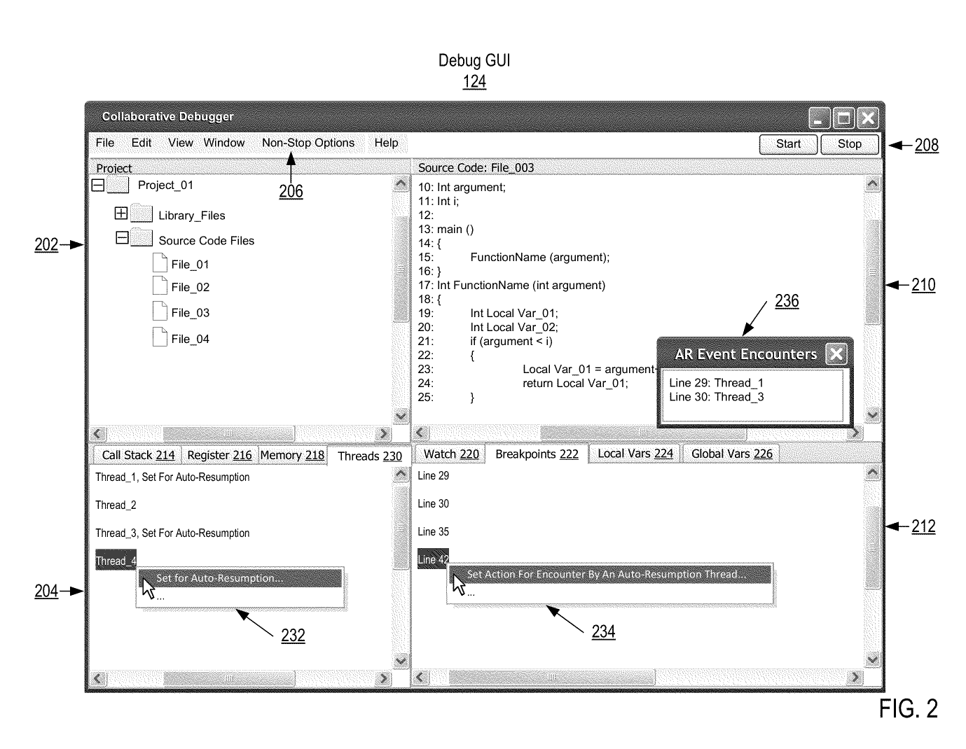

For further explanation, FIG. 2 sets forth an example non-stop debugging GUI (124) presented to a user in accordance with embodiments of the present invention. The example GUI (124) of FIG. 2 provides an interface for a user to control operation of a debugger that supports non-stop debugging. The debugger presenting the example GUI (124) of FIG. 2 is configured to debug a multi-threaded debuggee. That is, the debugger presenting the example GUI (124) of FIG. 2 and the multi-threaded debuggee form a non-stop debugging environment.

The example GUI (124) of FIG. 2 includes a menu bar (208) that, in turn, includes a number of separate menus: a File menu, an Edit menu, a View menu, a Non-Stop Options menu, and a Help menu. The Non-Stop Options menu (206), when selected, may provide a user with various menu items that support non-stop debugging.

The example GUI (124) of FIG. 2 also includes several independent portions—called panes (as in ‘window panes’) for clarity of explanation—a project pane (202), a source code pane (210), and two separate data panes (204, 212). Project pane (202) presents the files and resources available in a particular software development project. Source code pane (210) presents the source code of the multi-threaded debuggee. The data panes (204, 212) present various data useful in debugging the source code. In the example of FIG. 2, data pane (204) includes four tabs, each of which presents different data: a call stack tab (214), a register tab (214), a memory tab (218), and a threads tab (230). Data pane (212) includes four tabs: a watch list tab (220), a breakpoints (222) tab, a local variable tab (224), and a global variable tab (226).

The GUI (124) of FIG. 2 may support managing thread execution in a non-stop debugging environment in accordance with embodiments of the present invention. In the example of FIG. 2, a user has selected a thread in a threads tab (230) by controlling, with a user interface device, the position of a pointer and providing a user-initiated GUI action (a mouse-click or keyboard keystroke, for example). The user-initiated GUI action invoked presentation of a drop down selection list (232) that includes an option to set the selected thread for auto-resumption. Upon selection of the this option, the GUI (124) will generate and provide to the debugger a request to set the thread—‘Thread 4’ in this example—for auto-resumption.

Once one or more threads are set for auto-resumption, the debugger presenting the GUI (124) of FIG. 2 is configured to resume such threads automatically, without user interaction, when any such thread encounters an event. The debugger may also be configured to alert the user when such a thread encounters an event. In FIG. 2, for example, the GUI (124) includes a pop-up dialog box (236) alerting the user that Thread_{—}1 encountered a breakpoint at line 29 and Thread_{—}3 encountered a breakpoint at line 30. Execution of both threads was resumed without any user interaction. With the alert in the pop-up dialog box (236), the debug user is aware that a thread is encountering the breakpoint but, because execution of the thread is automatically resumed without the user's interaction, impact of the encounter is limited.

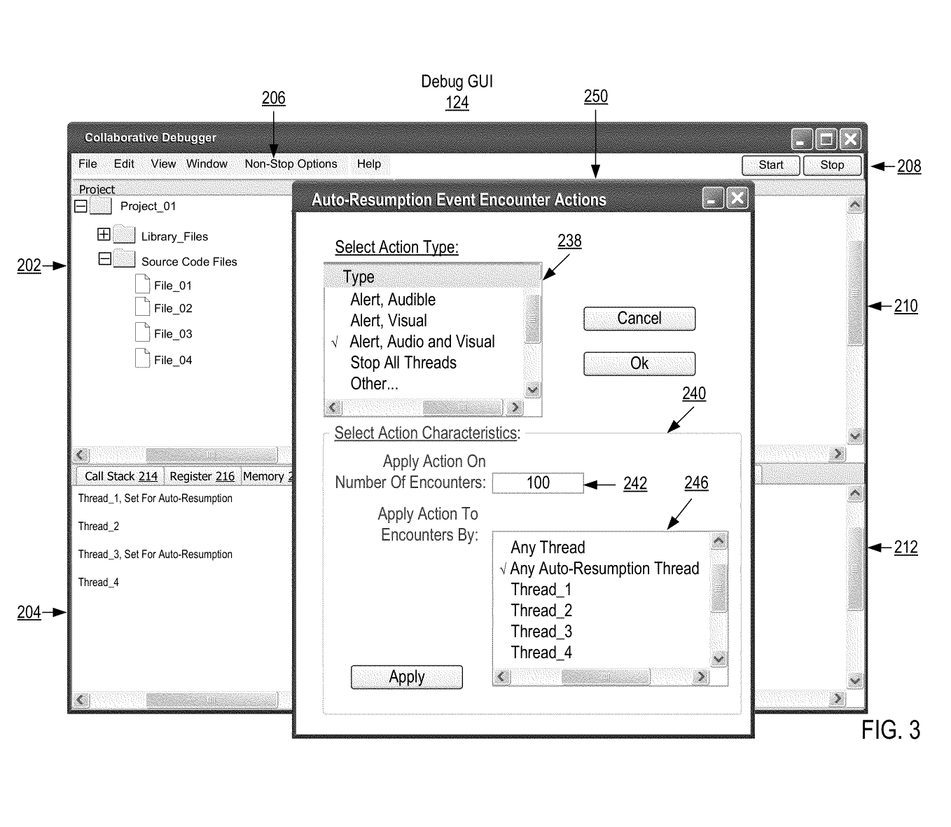

The example GUI (124) of FIG. 2 depicts two separate pointers for explanation only, not limitation. Readers of skill in the art will recognize that in most applications, only one mouse pointer will be depicted in the GUI (124) at a time. The first mouse pointer in the example of FIG. 2 is positioned above the drop-down selection list (232) and the second mouse pointer is positioned above the drop-down selection list (234). In the drop-down selection list (234) a user is presented with an option to assign an action to an event to be initiated when the event is encountered by a thread set for auto-resumption. Once a user selects this option, the user may be presented with various attributes to set for such an action. Such a presentation of an action's attributes is described below in further detail with regard to FIG. 3.

The GUI items, menus, window panes, tabs, and so on depicted in the example GUI (124) of FIG. 2, are for explanation, not for limitation. Other GUI items, menu bar menus, drop-down menus, list-boxes, window panes, tabs, and so on as will occur to readers of skill in the art may be included in GUIs presented by a debugger in a system configured for non-stop debugging in accordance with embodiments of the present invention.

For further explanation, FIG. 3 sets forth another example non-stop debugging GUI (124) presented to a user in accordance with embodiments of the present invention. The example GUI (124) of FIG. 3 is similar to the GUI of FIG. 2 in that the GUI (124) of FIG. 3 also provides an interface for a user to control operation of a debugger that supports non-stop debugging, where the debugger is configured to debug a multi-threaded debuggee, the debugger and the multi-threaded debuggee forming a non-stop debugging environment.

The example GUI (124) of FIG. 3 presents to a user a window (250) that includes various attributes which may be set for an action that is to be initiated upon an encounter of a particular event by a thread set for auto-resumption. In this window (250), a user may specify a type of action (238). Examples of actions to be initiated upon an encounter of an event by a thread set for auto-resumption include audible alerts, visual alerts, stopping execution of all threads, and others as will occur to readers of skill in the art.

In addition, a user may also specify in the window (250) a number of encounters (242) upon which to initiate the action. That is, the debugger may be configured to initiate the action upon a predefined number (a predefined threshold) of encounters of the event. A user, for example, may specify that upon a first encounter, a visual and audible alert be initiated. A user, as another example, may specify that an alert be initiated only after 100 encounters of the event—effectively ignoring the first 100 encounters of the event.

A user may also select, in the window (250) of FIG. 2, one or more threads for which an encounter initiates the selected action. A user may, for example, specify that the debugger initiates the selected action upon the predefined number (242) of encounters by any of the threads set for auto-resumption. A user may, as another example, specify that the debugger initiates the selected action upon the predefined number (242) of encounters by a particular thread set for auto-resumption—say, Thread_{—}1. In this way, a user may selectively set actions on a thread-specific basis.

Like the GUI in the example of FIG. 2, the GUI items, menus, window panes, tabs, and so on depicted in the example GUI (124) of FIG. 3, are for explanation, not for limitation. Other GUI items, menu bar menus, drop-down menus, list-boxes, window panes, tabs, and so on as will occur to readers of skill in the art may be included in GUIs presented by a debugger in a system configured for non-stop debugging in accordance with embodiments of the present invention.

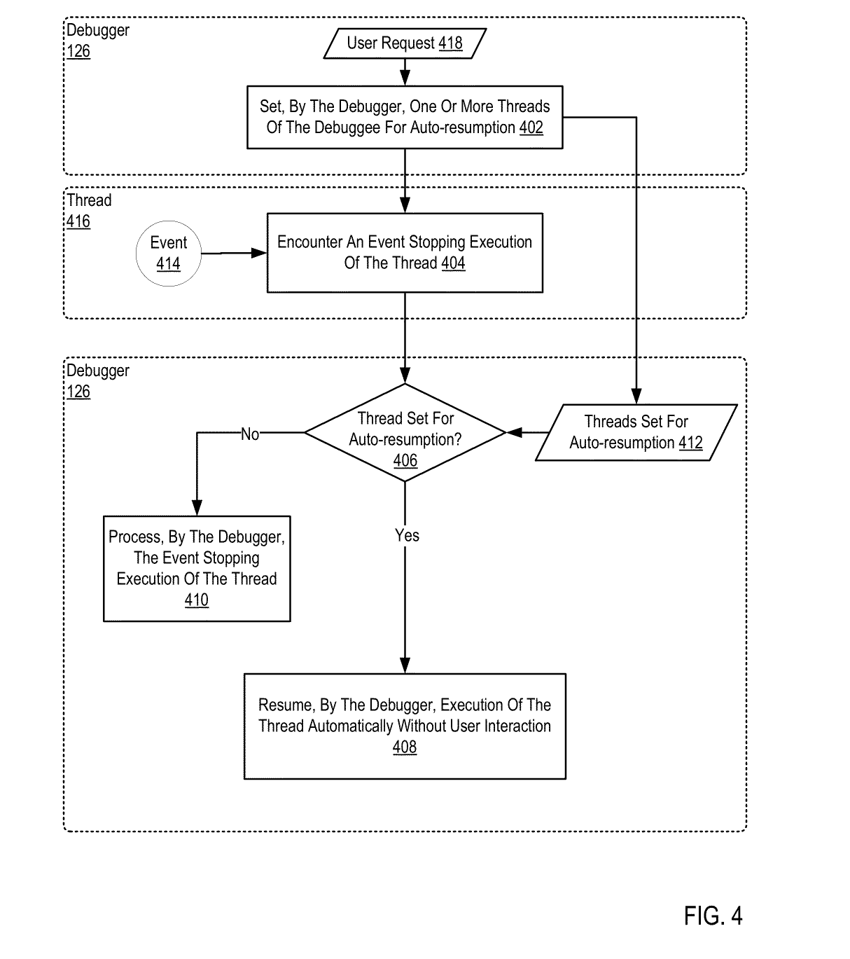

For further explanation, FIG. 4 sets forth a flow chart illustrating an exemplary method for managing thread execution in a non-stop debugging environment according to embodiments of the present invention. The non-stop debugging environment of FIG. 4 includes a debugger (126) configured to debug a multi-threaded debuggee. In the non-stop debugging environment, encountering an event by one of threads stops execution of only the one thread without concurrently stopping execution of other threads.

The method of FIG. 4 includes setting (402), by the debugger (126) responsive to one or more user requests (418), one or more threads (412) of the debuggee for auto-resumption. Setting (402) one or more threads of the debuggee for auto-resumption may be carried out in various ways including, for example, by storing, for each request, as a separate record of a data structure representing a thread set for auto-resumption, a thread identifier provided with the user requests (418). Consider, for example, that a user requests, through a GUI, that two threads with thread identifiers ‘Thread_{—}1’ and ‘Thread_{—}2’ be set for auto-resumption. In such an example, the debugger may store in a list the thread identifiers ‘Thread_{—}1’ and ‘Thread_{—}2.’ The list in this example is a list of a threads set for auto-resumption.

The front-end GUI may provide the back-end debugger the user requests (418) via a predefined command configured to set an auto-resumption attribute of a thread. An example of such a command may include: SetThreadAuto-Resume::True. Readers of skill in the art will recognize that this command is only an example and many variations of such a command may be configured as a user request to set a thread for auto-resumption. Each such variation of a command is well within the scope of the present invention.

The method of FIG. 4 also includes encountering (404), by a thread (416) of the debuggee, an event (414) stopping execution of the thread. Encountering (404) an event (414) stopping execution of the thread may be carried out in various ways including, for example, by encountering a breakpoint, a watchpoint, a catchpoint, and so on as will occur to readers of skill in the art.

The method of FIG. 4 also includes determining (406), by the debugger (126), whether the thread (416) is set for auto-resumption. Determining (406) whether the thread (416) is set for auto-resumption may be carried out, for example, by searching the list (described above) of threads set for auto-resumption with the thread identifier of the thread (416) that encountered the event (414). If the thread identifier is included in the list, the thread (416) is set for auto-resumption and if the thread identifier is not included in the list, the thread (416) is not set for auto-resumption.

If the thread (416) is set for auto-resumption, the method of FIG. 4 continues by resuming (408), by the debugger (126), execution of the thread automatically without user interaction. If the thread (416) is not set for auto-resumption, the method of FIG. 4 continues by processing (410), by the debugger (126), the event (414) stopping execution of the thread (416). Processing (410) the event (414) stopping execution of the thread (416) may be carried out in various ways including, for example, by changing the debug perspective of the GUI to information describing the thread (416) encountering the event, displaying on the GUI variable values, expressions, event information, call stacks, and the like, associated with the thread encountering the event or the event itself, and so on as will occur to readers of skill in the art.

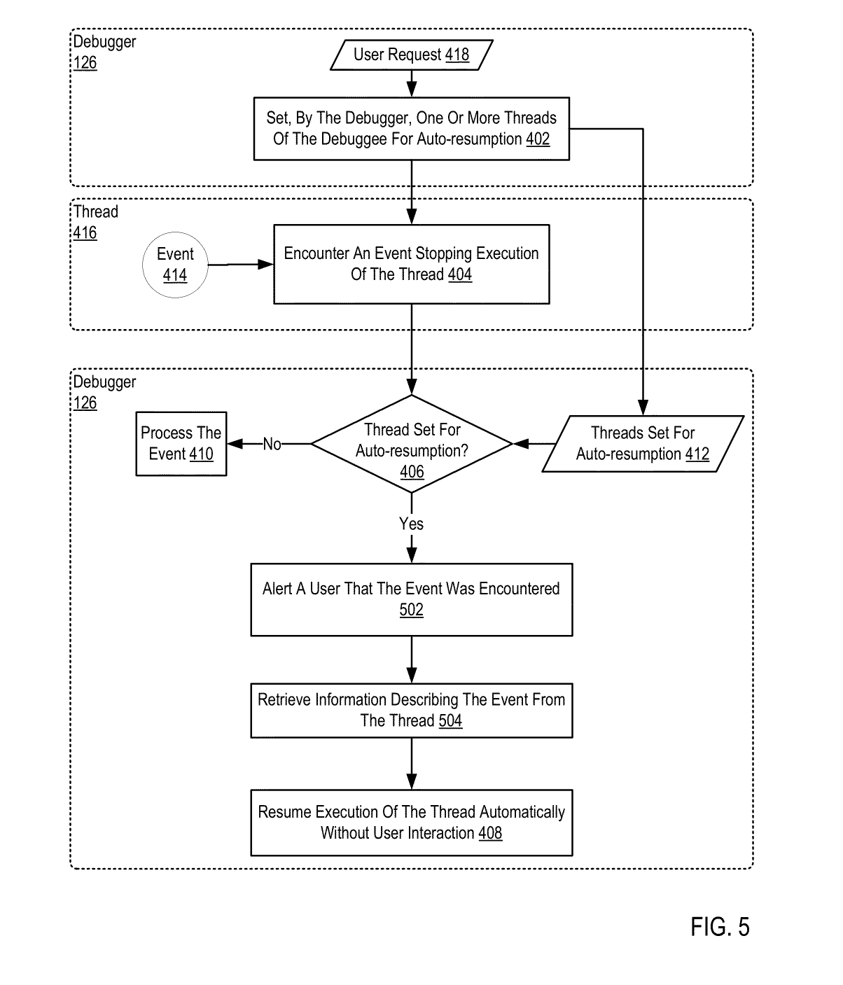

For further explanation, FIG. 5 sets forth a flow chart illustrating a further exemplary method for managing thread execution in a non-stop debugging environment according to embodiments of the present invention. The method of FIG. 5 is similar to the method of FIG. 4 in that the non-stop debugging environment of the method of FIG. 5 also includes a debugger (126) configured to debug a multi-threaded debuggee, where encountering an event by one of threads stops execution of only the one thread without concurrently stopping execution of other threads. The method of FIG. 5 is also similar to the method of FIG. 4 in that the method of FIG. 5 includes setting (402) one or more threads (412) of the debuggee for auto-resumption; encountering (404), by a thread (416), an event (414) stopping execution of the thread; determining (406), by the debugger (126), whether the thread (416) is set for auto-resumption; if the thread (416) is set for auto-resumption, resuming (408), by the debugger (126), execution of the thread automatically without user interaction; and if the thread (416) is not set for auto-resumption, processing (410), by the debugger (126), the event (414) stopping execution of the thread (416).

The method of FIG. 5 differs from the method of FIG. 4, however, in that the method of FIG. 5 also includes alerting (502), by the debugger (126), the user that the event was encountered if the thread is set for auto-resumption. Alerting the user that the event was encountered may be carried out in various ways including for example, by a visual message depicted in a GUI, by playing an audible alert, maintaining and displaying a list of event encounters by threads set for auto-resumption, some combination of these, and so on as will occur to readers of skill in the art.

The method of FIG. 5 also includes retrieving (504), by the debugger (126), information describing the event from the thread prior to resuming (408) execution of the thread. Retrieving (504) information describing the event from the thread prior to resuming (408) execution of the thread may be carried out in various ways including, for example, by retrieving a program counter that indicates a memory location of a computer program instructions executed upon the encounter, register contents in use by the thread upon the encounter, and other information describing the thread as will occur to readers of skill in the art. Rather than changing the debug perspective to the thread and displaying the retrieved information, the debugger (126) may store the data for later on-demand retrieval by the user. In this way, data useful to software development—data describing the thread as well as the encounter—is available to the developer, even if the thread is resumed immediately (or nearly so) without the developer's knowledge at the time.

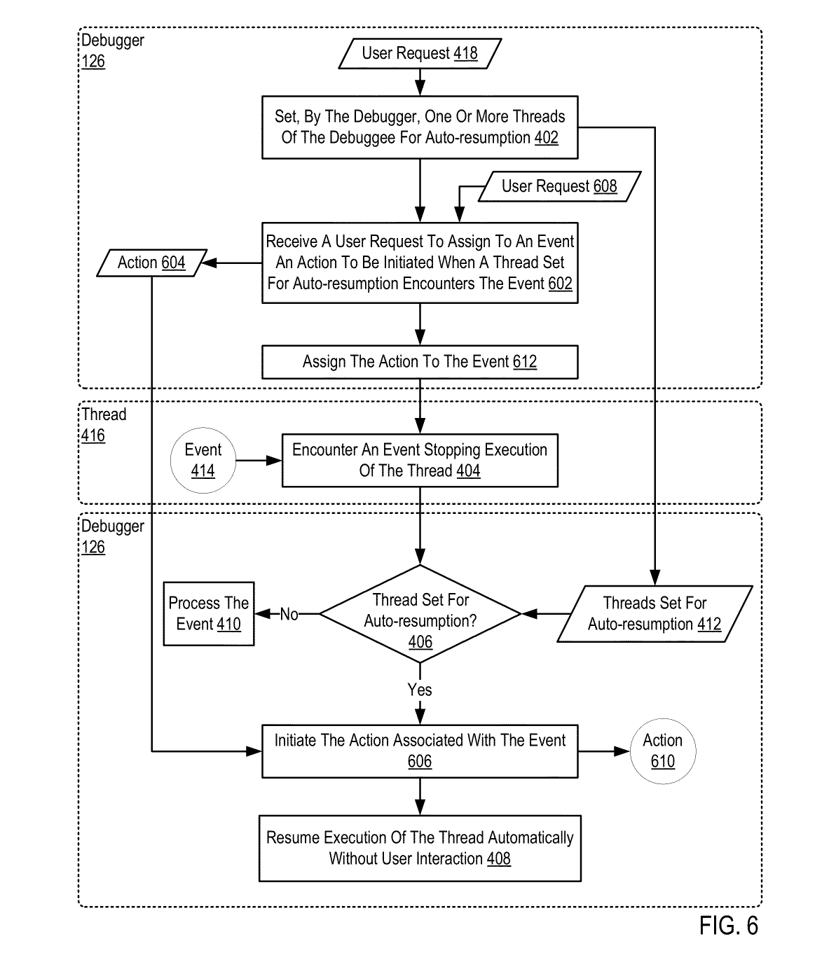

For further explanation, FIG. 6 sets forth a flow chart illustrating a further exemplary method for managing thread execution in a non-stop debugging environment according to embodiments of the present invention. The method of FIG. 6 is similar to the method of FIG. 4 in that the non-stop debugging environment of the method of FIG. 6 also includes a debugger (126) configured to debug a multi-threaded debuggee, where encountering an event by one of threads stops execution of only the one thread without concurrently stopping execution of other threads. The method of FIG. 6 is also similar to the method of FIG. 4 in that the method of FIG. 6 includes setting (402) one or more threads (412) of the debuggee for auto-resumption; encountering (404), by a thread (416), an event (414) stopping execution of the thread; determining (406), by the debugger (126), whether the thread (416) is set for auto-resumption; if the thread (416) is set for auto-resumption, resuming (408), by the debugger (126), execution of the thread automatically without user interaction; and if the thread (416) is not set for auto-resumption, processing (410), by the debugger (126), the event (414) stopping execution of the thread (416).

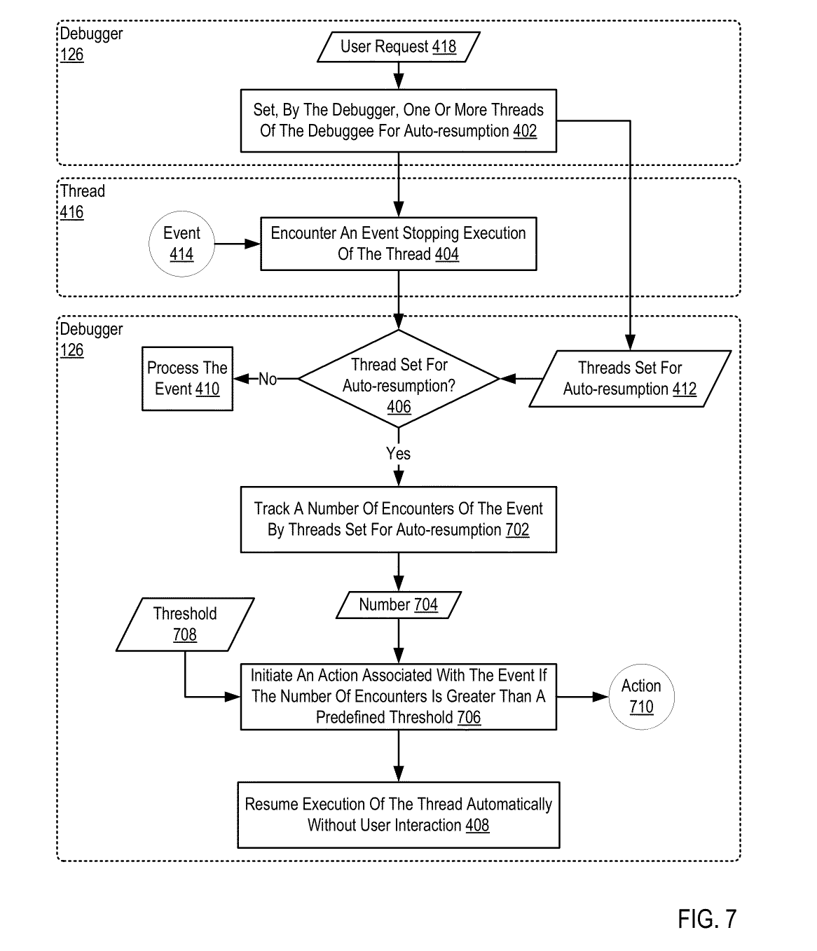

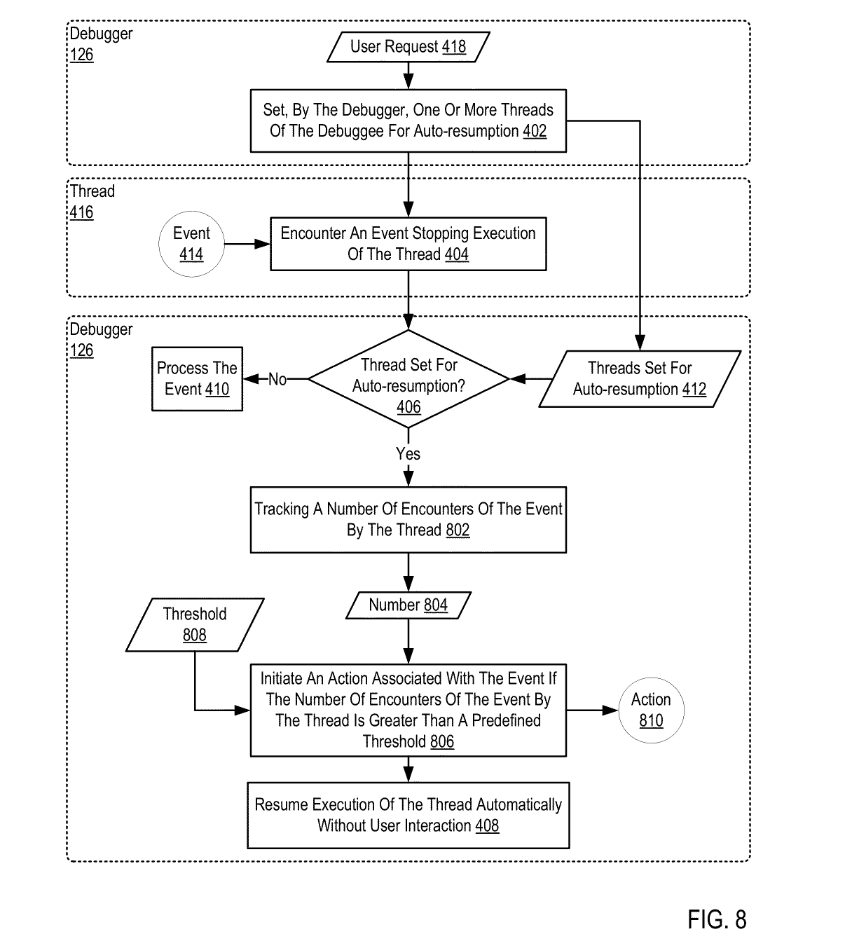

FIG. 6 differs from the method of FIG. 4, however, in that the method of FIG. 6 includes receiving (602), by the debugger (126), a user request (608) to assign to an event an action (610) to be initiated when a thread set for auto-resumption encounters the event. Receiving (602) a user request (608) to assign to an event an action (610) to be initiated when a thread set for auto-resumption encounters the event may be carried out in various ways including, for example, by receiving from the front-end GUI a command generated at the behest of the user's interaction with the GUI to set one or more action attributes of an event. That is, in some embodiments an event—a breakpoint, for example—may be described by one or more attributes, such as an action attribute. An action attribute may be set to specify a type of action to be initiated among other possible options described below with respect to FIGS. 7 and 8.

The method of FIG. 6 includes assigning (612), by the debugger (126), the action (610) to the event and initiating (606), by the debugger (126), the action associated with the event if the thread is set for auto-resumption and the thread encounters (404) the event (414). Assigning (612), by the debugger (126), the action (610) to the event may include storing values specified in the command described above in association with an event descriptor. Initiating (606) the action associated with the event may be carried out by identifying from the values stored in associated with the event descriptor an action type and carrying out the identified action.

For further explanation, FIG. 7 sets forth a flow chart illustrating a further exemplary method for managing thread execution in a non-stop debugging environment according to embodiments of the present invention. The method of FIG. 7 is similar to the method of FIG. 4 in that the non-stop debugging environment of the method of FIG. 7 also includes a debugger (126) configured to debug a multi-threaded debuggee, where encountering an event by one of threads stops execution of only the one thread without concurrently stopping execution of other threads. The method of FIG. 7 is also similar to the method of FIG. 4 in that the method of FIG. 7 includes setting (402) one or more threads (412) of the debuggee for auto-resumption; encountering (404), by a thread (416), an event (414) stopping execution of the thread; determining (406), by the debugger (126), whether the thread (416) is set for auto-resumption; if the thread (416) is set for auto-resumption, resuming (408), by the debugger (126), execution of the thread automatically without user interaction; and if the thread (416) is not set for auto-resumption, processing (410), by the debugger (126), the event (414) stopping execution of the thread (416).

The method of FIG. 7 differs from the method of FIG. 4, however, in that the method of FIG. 7 includes tracking (702) a number (704) of encounters of the event by threads set for auto-resumption and initiating (706) an action (710) associated with the event if the thread is set for auto-resumption and if the number of encounters is greater than a predefined threshold (708). Tracking (702) a number (704) of encounter of the event by threads set for auto-resumption may be carried out in various ways including incrementing a counter associated with the event upon each encounter of the event by a thread set for auto-resumption. Then, prior to resuming (408) execution of the thread set for auto-resumption, the debugger may initiate (706) an action (710) associated with the event by determining whether the current value of the counter is greater than the predefined threshold (708). If the current value of the counter is greater than the predefined threshold (708), the debugger initiates the action associated with the event. In this example, the number of encounters of an event is tracked for any thread set for auto-resumption. That is, an encounter by any thread set for auto-resumption increments the counter. In some other embodiments, such as those described below with regard to FIG. 8, a number of encounters may be tracked on a thread-specific basis.

For further explanation, FIG. 8 sets forth a flow chart illustrating a further exemplary method for managing thread execution in a non-stop debugging environment according to embodiments of the present invention. The method of FIG. 8 is similar to the method of FIG. 4 in that the non-stop debugging environment of the method of FIG. 8 also includes a debugger (126) configured to debug a multi-threaded debuggee, where encountering an event by one of threads stops execution of only the one thread without concurrently stopping execution of other threads. The method of FIG. 8 is also similar to the method of FIG. 4 in that the method of FIG. 8 includes setting (402) one or more threads (412) of the debuggee for auto-resumption; encountering (404), by a thread (416), an event (414) stopping execution of the thread; determining (406), by the debugger (126), whether the thread (416) is set for auto-resumption; if the thread (416) is set for auto-resumption, resuming (408), by the debugger (126), execution of the thread automatically without user interaction; and if the thread (416) is not set for auto-resumption, processing (410), by the debugger (126), the event (414) stopping execution of the thread (416).

The method of FIG. 8 differs from the method of FIG. 4, however, in that method of FIG. 8 includes tracking (802) a number (804) of encounters of the event by the thread and initiating (806) an action (810) associated with the event if the thread (416) is set for auto-resumption and if the number (804) of encounters of the event by the thread is greater than a predefined threshold (808). In this example, the debugger may track a number of encounters of an event on a thread-specific basis in various ways including, for example, by maintaining, for each event, a separate counter for each thread set for auto-resumption. In such an embodiment, the debugger may initiate (806) the action (810) by determining whether the current value of the counter for the thread (416) is greater than the predefined threshold. If the current value of the counter for the thread (416) is greater than the predefined threshold (708), the debugger initiates the action (810) associated with the event. In this way, a user may selectively set the threshold (608) on a thread-specific and event specific basis. Such an embodiment provides a user with fine grain control over actions carried out upon encounters of an event by a thread or threads set for auto-resumption.

In view of the explanations set forth above, readers will recognize that the benefits of managing execution of threads in a non-stop debugging environment according to embodiments of the present invention include:
Enabling a user controlling a debugger to selectively set threads to be effectively ‘unstoppable.’
Limiting debugging impact on users of threads.
Providing a user with information regarding event encounters of threads set for auto-resumption.
Enabling fine grain user control over action associated with event encounters by threads set for auto-resumption.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable transmission medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable transmission medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable transmission medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method of managing thread execution in a non-stop debugging environment, the non-stop debugging environment comprising a debugger configured to debug a debuggee comprising a plurality of threads of execution, wherein encountering an event by one of the threads stops execution of only the one thread without concurrently stopping execution of other threads, the method comprising:
responsive to one or more user requests, setting, by the debugger, one or more threads of the debuggee for auto-resumption;
encountering, by a thread of the debuggee, an event stopping execution of the thread;
determining, by the debugger, whether the thread is set for auto-resumption;
if the thread is set for auto-resumption, resuming, by the debugger, execution of the thread automatically without user interaction; and
if the thread is not set for auto-resumption, processing, by the debugger, the event stopping execution of the thread.

2. The method of claim 1, further comprising alerting, by the debugger, the user that the event was encountered if the thread is set for auto-resumption.

3. The method of claim 1, further comprising retrieving, by the debugger, information describing the event from the thread prior to resuming execution of the thread.

4. The method of claim 1, further comprising:
receiving, by the debugger, a user request to assign to an event an action to be initiated when a thread set for auto-resumption encounters the event;
assigning, by the debugger, the action to the event; and
initiating, by the debugger, the action associated with the event if the thread is set for auto-resumption.

5. The method of claim 1, further comprising:
tracking a number of encounters of the event by threads set for auto-resumption; and
initiating an action associated with the event if the thread is set for auto-resumption and if the number of encounters is greater than a predefined threshold.

6. The method of claim 1, further comprising:
tracking a number of encounters of the event by the thread; and
initiating an action associated with the event if the thread is set for auto-resumption and if the number of encounters of the event by the thread is greater than a predefined threshold.

7-20. (canceled)
